(19) United States
(12) Patent Application Publication
(10) Pub. No.: US 2021/0129515 A1
(43) Pub. Date: May 6, 2021

(54) RESIDUAL LAYER REMOVAL METHOD, RESIDUAL LAYER REMOVAL DEVICE, AND DISPLAY MODULE

(71) Applicant: SHARP KABUSHIKI KAISHA, Sakai City, Osaka (JP)

(72) Inventor: TAKAAKI HIRANO, Sakai City, Osaka (JP)

(73) Assignee: SHARP KABUSHIKI KAISHA, Sakai City, Osaka (JP)

(21) Appl. No.: 16/616,816

(22) PCT Filed: May 24, 2018
(86) PCT No.: PCT/JP2018/019982

§ 371 Date: Nov. 25, 2019

(30) Foreign Application Priority Data
May 31, 2017 (JP) 2017-107641

(51) Int. Cl. B32B 37/12; G02F 1/1339

(52) U.S. Cl. CPC B32B 37/1207; B32B 2457/202; G02F 2202/28; G02F 1/1339

(57) ABSTRACT

A residual layer removal method of removing a residual layer of an adhesive resin attached to a substrate used in a display module, the residual layer removal method includes: an arranging step of arranging a metal porous material on a surface of the residual layer; a heating step of heating and softening the residual layer; a pressing step of pressing the metal porous material arranged on the surface of the residual layer by the arranging step to the residual layer softened. by the heating step to press-fit at least parts of the residual layer into open holes of the metal porous material; and a peeling step of peeling off the metal porous material in which the residual layer is press-fitted into the open holes from the substrate.

### TECHNICAL FIELD

The present technology relates to a residual layer removal method, a residual layer removal device, and a display module.

### BACKGROUND ART

As a display module, a display module including a display panel configured to display an image, a driver (integrated circuit (IC) chip) driving the display panel, a control circuit board supplying various input signals from the outside to the drive, and a flexible printed circuit (FPC) board (flexible circuit board) electrically connecting the external control circuit board and the display panel to each other has been known. Electrical components such as the driver, the FPC board or the like are usually bonded and fixed and are electrically connected onto a glass substrate constituting the display panel through an anisotropic conductive adhesive (ACF) or the like. In the present description, any component provided with a contact portion that performs electrical connection by contact is referred to as an electrical component.

In a process of producing such a display module, an operation confirmation is appropriately performed. For example, after the electrical components such as the driver or the FPC board are connected onto the substrate, a lighting inspection is performed. In a case where a semi-finished product of the display module in which the electrical components are assembled is determined to be unsuitable in the lighting inspection because of an operation defect due to damage or the like of the electrical component or a connection defect due to positional deviation or the like of the electrical component, depending on a symptom or a state, rework (repair) that replaces only the electrical component in which the defect has occurred and reuses members other than the electrical component is performed.

For example, in order to regenerate the substrate such that the substrate can be reused, it is necessary to first detach the electrical component in which the defect has occurred from the substrate and then remove a residual layer of an adhesive resin such as the ACF or the like attached onto the substrate. This is because it is likely that a connection defect will occur when the display module is produced using the substrate with the adhesive resin remaining, and it is preferable to completely remove the residual layer of the adhesive resin from the substrate at the time of regenerating the substrate. However, the adhesive resin in which curing proceeds is firmly attached to the substrate, such that it is not easy to completely remove the residual layer of the adhesive resin. A method of forcibly peeling off the residual layer of the adhesive resin by applying external force using a bamboo spatula or the like, or wiping off the residual layer by applying a softener of the adhesive resin has been performed. However, such a method has a problem that it is difficult and takes time to perform work and the substrate or the like may be damaged.

Therefore, Patent Document 1 discloses a method of softening an adhesive resin. (adhesive member) by heating and then scraping or wiping off the adhesive resin from a substrate. Further, Patent Document 2 discloses a method of fusing an adhesive resin (connection member) softened by heating to an adhesive film having a high adhesive force and transferring the adhesive resin to an adherend such as a rough surface copper foil or the like to remove the adhesive resin from a substrate.

### RELATED ART DOCUMENT

### Patent Document

Patent Document 1: Japanese Unexamined Patent Application Publication No. 2011-108888

Patent Document 2: Japanese Unexamined Patent Application Publication No. 2007-324237.

### Problem to be Solved by the Invention

However, in the method of Patent Document 1, there is a possibility that a residue of the adhesive resin melted in a jelly shape by the heating will remain on the substrate as a thin film of an invisible level. Further, in the method of Patent Document 2, when a peel resistance from the adherend becomes smaller than a peel resistance from the substrate due to a variation in a surface state of the rough surface copper foil which is the adherend, formation of an oxide film, or the like, there was a possibility that the transfer would not be performed well and the residual layer of the adhesive resin would not be removed from the substrate.

### DISCLOSURE OF THE PRESENT INVENTION

The present technology has been completed on the basis of the above situation, and an object of the present technology is to provide a residual layer removal method of removing a residual layer of an adhesive resin attached to a substrate for a display module while reducing a failure rate or stabilizing a work and shortening a work time in regenerating the substrate. In addition, the present description also discloses a residual layer removal device that enables removal of a residual layer of an adhesive resin attached to a substrate for a display module while reducing a failure rate or stabilizing a work and shortening a work time, and a display module using a regenerated substrate.

### Means for Solving the Problem

A technology disclosed in the present description provides a residual layer removal method of removing a residual layer of an adhesive resin attached to a substrate used in a display module, including: an arranging step of arranging a metal porous material on a surface of the residual layer; a heating step of heating and softening the residual layer; a pressing step of pressing the metal porous material arranged on the surface of the residual layer by the arranging step to the residual layer softened by the heating step to press-fit at least parts of the residual layer into open holes of the metal porous material; and a peeling step of peeling off the metal porous material in which the residual layer is press-fitted into the open holes from the substrate. Here, the metal porous material refers to a material having open holes opened at least in a surface thereof pressed to the surface of the residual layer. It is preferable that the metal porous material is a planar body.

According to the above configuration, at least parts of the residual layer formed of the heated and softened adhesive resin are press-fitted into the open holes of the metal porous material, such. that an adhesive force between the residual layer and the metal porous material is increased, and this adhesive force can be made larger than an adhesive force between the residual layer and the substrate. Thus, when the metal porous material is stripped from the substrate, the residual layer attached to the metal porous material can be entangled with the metal porous material to be removed together with the metal porous material from the substrate. Since the metal porous material has an excellent heat resistance, the pressing of the metal porous material to the heated residual layer can be stably performed. In addition, in the peeling step, it is sufficient if the metal porous material having an excellent mechanical strength is peeled off. Therefore, a work can be easily performed, and damage to the substrate when removing the residual layer is suppressed, such that a breakage rate (a failure rate) can be reduced.

Note that a sequence of the heating step and the arranging step is not important. That is, the heating step may be performed before, be formed simultaneously with, or be performed after the arranging step, or may be performed continuously for a certain period before and after the arranging step. In addition, the pressing step is performed after the arranging step and the heating step, but it is preferable that the heating of the residual layer is continuously performed during the pressing step from the viewpoint of sufficiently softening the residual layer to facilitate the press-fitting of the residual layer into the metal porous material. Whether or not to heat the residual layer in the peeling step can be appropriately determined depending on a thermal property of the adhesive resin, a shape of the metal porous material, or the like.

In addition, the present description discloses a residual layer removal device of removing a residual layer of an adhesive resin attached to a substrate used in a display module.

The residual layer removal device disclosed in the present description includes: a base on which the substrate is arranged; a heating mechanism that heats and softens the residual layer; a pressing mechanism that presses a metal porous material arranged on a surface of the residual layer to the residual layer softened by the heating mechanism to press-fit at least parts of the residual layer into open holes of the metal porous material; and a peeling mechanism that peels off the metal porous material in which the residual layer is press-fitted into the open holes from the substrate.

If the residual layer removal device having the above configuration is used, it is possible to efficiently remove the residual layer of the adhesive resin attached to the substrate while reducing a failure rate or stabilizing a work and shortening a work time in regenerating the substrate for the display module.

In addition, the present description discloses a display module using a substrate regenerated by removing a residual layer of an adhesive resin attached to the substrate.

The display module disclosed in the present description uses the substrate generated by removing the residual layer of the adhesive resin attached to the substrate by a residual layer removal method including: an arranging step of arranging a metal porous material on a surface of the residua layer; a heating step of heating and softening the residual layer; a pressing step of pressing the metal porous material arranged on the surface of the residual layer by the arranging step to the residual layer softened by the heating step to press-fit at least parts of the residual layer into open holes of the metal porous material; and a peeling step of peeling off the metal porous material in which the residual layer is press-fitted into the open holes from the substrate.

According to the above configuration, by using the regenerated substrate, it is possible to achieve cost reduction of a display module. In addition, by using the regenerated substrate from which the residual layer of the adhesive resin attached to the substrate is removed with a high probability, it is possible to reduce occurrence of a detect due to the regenerated substrate in the display module.

### Advantageous Effect of the Invention

As described above, according to the technology disclosed in the present description, the residual layer of the adhesive resin attached to the substrate is efficiently removed, such that the substrate can be easily reused.

### BRIEF DESCRIPTION OF THE DRAWINGS

FIG. 1 is a schematic view showing a planar configuration of a liquid crystal module according to a first embodiment.

FIG. 2 is a cross-sectional view schematically showing a state of detaching an electrical component from a liquid crystal panel.

FIG. 3 is an enlarged view of a remaining portion of an anisotropic conductive adhesive (ACF) of the liquid crystal panel after the electrical component is detached.

FIG. 4 is a cross-sectional view schematically showing an arranging step.

FIG. 5 is a cross-sectional view schematically showing a state before a heating pressing step.

FIG. 6 is a cross-sectional view schematically showing a state during the heating pressing step.

FIG. 7 i s a cross-sectional view schematically showing a state after the heating pressing step.

FIG. 8 is a cross-sectional view schematically showing a state of a peeling step.

FIG. 9 is a plan view schematically showing a configuration of a metal mesh.

FIG. 10A is an image view showing; a cross section of a residual layer after the heating pressing step.

FIG. 10B is an image view showing a cross section of the residual layer after the heating pressing step.

FIG. 11 is a cross-sectional view schematically showing a state of a metal mesh and a residual layer according to a second embodiment.

FIG. 12 is a cross-sectional view schematically showing a state of a metal mesh and a residual layer according to a third embodiment.

FIG. 13 is a cross-sectional view schematically showing a state of heating and pressing a metal mesh and then peeling off the metal mesh together with a residual layer according to a fourth embodiment.

### MODES FOR CARRYING OUT THE INVENTION

### First Embodiment

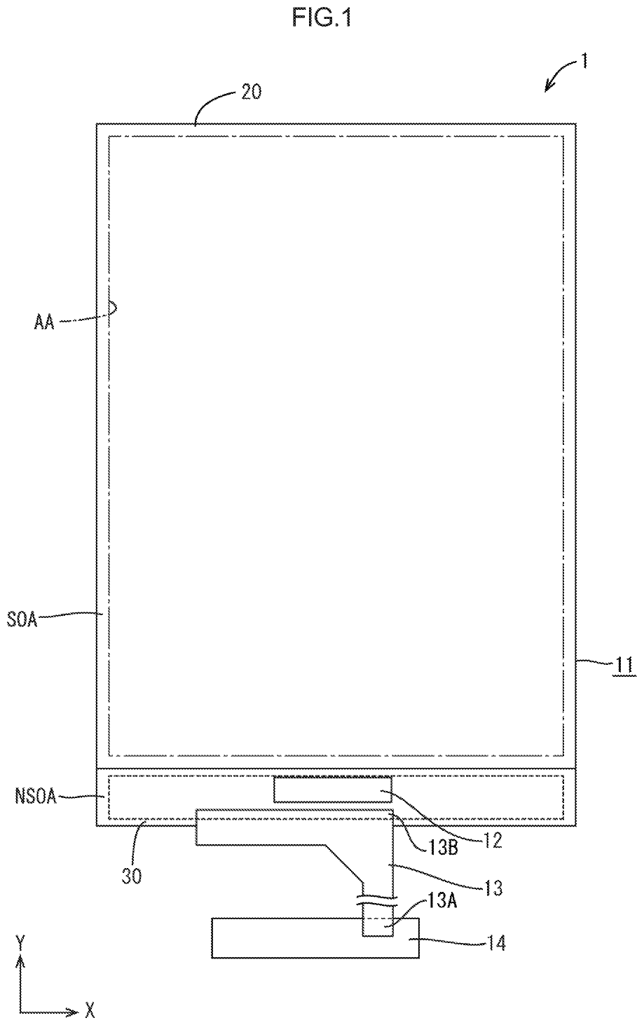

A first embodiment will be described with reference to FIGS. 1 to 10A and 10B.

In the present embodiment, removal of an anisotropic conductive adhesive (ACF) residual layer from an array substrate constituting a liquid crystal panel (an example of a display panel) of a liquid crystal module (an example of a display module) is exemplified. Note that an X axis, a Y axis, and a Z axis are shown in some of the drawings, and each axis direction is drawn to be a direction shown in each drawing. In addition, an upper side in FIG. 1 is referred to as an upper side (a lower side in FIG. 1 is referred to as a lower side), a right side in FIG. 1 s referred to as a right side (a left side in FIG. 1 is referred to as a left side), a front side of a paper is referred to as a front side (a back side of the paper is referred to as a back side), and reference numerals may be given to some of members that are the same as each other and may be omitted for the other members.

As shown in FIG. 1, the liquid crystal module 1 includes a liquid crystal panel 11 configured to display an image. The liquid crystal panel 11 is connected to various electrical components necessary for displaying an image. Specifically, at least a driver (an IC chip and an example of an electrical component) 12 driving the liquid crystal panel 11, a control board a control circuit board, an external signal supply source, and an example of an electrical component) 14 supplying various input signals from the outside to the driver 12, and a flexible printed circuit (FPC) board (a flexible circuit board and an example of an electrical component) 13 electrically connecting the liquid crystal panel 11 and the external control board 14 to each other are included.

First, the liquid crystal panel 11 will be briefly described.

As shown in FIG. 1, the liquid crystal panel 11 has a vertically long rectangular shape (rectangular shape) as a whole, and a display area (active area) AA configured to display an image is formed at a central portion of a plate surface of the liquid crystal panel 11.

The liquid crystal panel 11 includes a pair of substrates 20 and 30. A front side substrate of the substrate 20 and 30 is a CF substrate (a color filter substrate or a counter substrate) 20 and a back side substrate of the substrate 20 and 30 is an array substrate (a thin film transistor (TFT) substrate or an active matrix substrate) 30. In the present embodiment, the array substrate 30 corresponds to a substrate in the claims. In the CF substrate 20, color filters in which respective colored portions such as red (R), green (G), blue (B) and the like are arranged in a predetermined array, counter electrodes, an alignment film, and the like are provided on an inner surface (a back surface) of a glass substrate. On the other hand, in the array substrate 30, switching elements (for example, TFTs) connected to source lines and gate lines orthogonal to each other, pixel electrodes connected to the switching elements, an alignment film and the like are provided on an inner surface (a front surface) of a glass substrate.

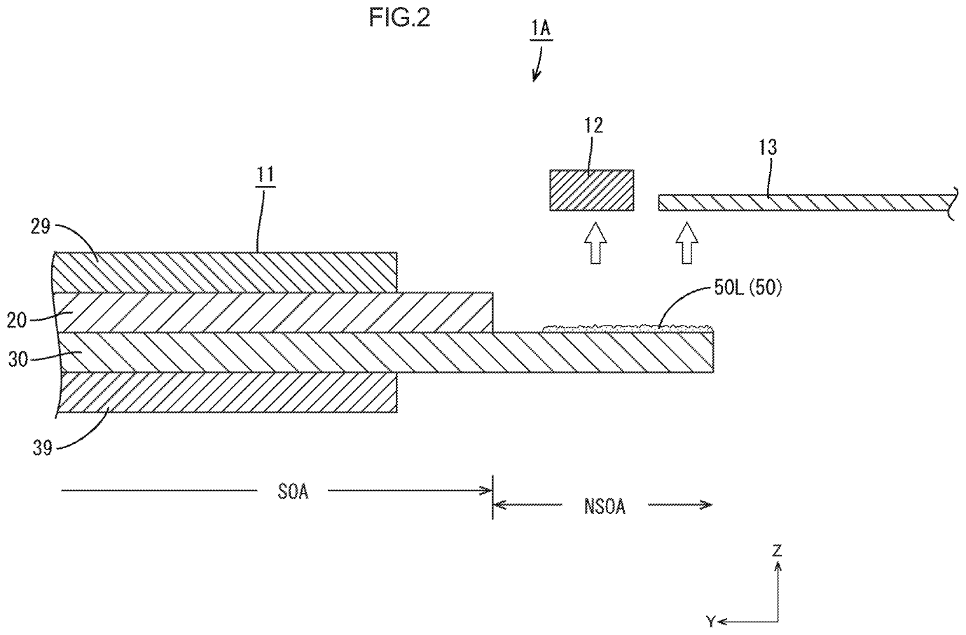

Although not shown in the drawing, the liquid crystal panel 11 includes a liquid crystal layer sandwiched between both the substrates 20 and 30 and a sealing material interposed between both the substrates 20 and 30 and sealing the liquid crystal layer, in addition to the pair of substrates 20 and 30 described above. The liquid crystal layer includes liquid crystal molecules whose optical characteristics change in accordance with application of an electric field, and is arranged so as to cover the entire display area AA. A front polarizing plate 29 and a back polarizing plate 39 are attached, respectively, to outer surface sides of both the substrates 20 and 30 in the display area AA (see FIG. 2 or the like).

The switching elements of the array substrate 30 described above are driven on the basis of various signals supplied to the gate lines and the source lines, and the supply of a potential to the pixel electrodes is controlled in accordance with the driving of the switching elements. In addition, a common electrode (not shown) is provided so as to overlap the pixel electrodes, and when a potential difference is generated between these electrodes, a fringe electric field (an oblique electric field) including a component in a normal direction to the plate surface of the array substrate 30 is applied to the liquid crystal layer. By applying the electric field, optical characteristics of the liquid crystal molecules included in the liquid crystal layer is changed, such that light transmittance are changed and an image is displayed on the display area AA.

As shown in FIG. 1, the glass substrates constituting the pair of substrates 20 and 30 have the same length in a horizontal direction (an X-axis direction), but a length in a vertical direction (a Y-axis direction) is set to be smaller in the glass substrate of the CF substrate 20 than in the glass substrate of the array substrate 30, and the two glass substrates are arranged to face each other with their upper ends aligned with each other. Hereinafter, in the liquid crystal panel 11, an area where the array substrate 30 and the CF substrate 20 overlap each other is referred to as a substrate overlapping area SOA, and an area below the array substrate 30 that the CF substrate 20 does not overlap is referred to as a non-substrate overlapping area NSOA. The display area AA described above is formed in the substrate overlapping area. SCA, while a driver 12 and an FPC board 13 as described later are mounted in the non-substrate overlapping area NSOA.

Next, electrical components connected to the array substrate 30 of the liquid crystal panel 11, that is, the control board 14, the FPC board 13, and the driver 12 will be sequentially described.

As the control board 14, for example, board in which electronic components for supplying various input signals to the driver 12 are mounted on a substrate formed of paper phenol or a glass epoxy resin and lines (conductive paths) of a predetermined pattern (not shown) are formed can be used. One end portion (one end side) of the FPC board 13 is electrically and mechanically connected to the control board 14 through an anisotropic conductive adhesive (ACF) (an example of an adhesive resin) 50 as described later.

The FPC board 13 includes a substrate formed of a synthetic resin material (polyimide resin or the like) having an insulating property and flexibility, and has line patterns (not shown) formed on the substrate. As shown in FIG. 1, one end portion (one end side) 13A of the FPC board 13 in a length direction is connected to the control board 14 described above, while the other end portion (the other end side) 13B of the FPC board 13 in the length direction is connected to the other end portion of the array substrate 30 in a long side direction, and the FPC board 13 can be bent in a folded shape such that a cross-sectional shape is substantially a U shape in the liquid crystal module 1. At both end portions 13A and 13B of the FPC board 13 in the length direction, line patterns are exposed to the outside to constitute terminal portions (not shown), and these terminal portions are electrically connected to the control board 14 and the array substrate 30, respectively. Thus, an input signal supplied from the control board 14 can be transmitted to the liquid crystal panel 11.

The driver 12 has a drive circuit arranged therein, and includes lines or elements formed on a silicon wafer containing silicon with high purity. The driver 12 generates an output signal on the basis of a signal supplied from the control board 14 which is the signal supply source, and outputs the output signal toward the display area AA of the liquid crystal panel 11. The driver 12 is directly mounted on the substrate non-substrate overlapping area NSOA of the array substrate 30, that is, is mounted in a chip on glass (COG) manner.

Next, a connection aspect between the array substrate 30 of the liquid crystal panel 11, the FPC board 13, and the driver 12 will be described.

The FPC board 13 is connected such that the other end portion 13B of the FPC board 13 extends along a lower end edge of the array substrate 30 at substantially a central portion in the horizontal direction (the X-axis direction) of a lower end portion of the non-substrate overlapping area NSOA, in a posture in which the length direction of the FPC board 13 is along the long side direction (the Y-axis direction) of the array substrate 30, as shown in FIG. 1.

A mounting area of the FPC board 13 in the non-substrate overlapping area. NSOA of the array substrate 30 is provided with an FTC connection terminal portion (not shown) for receiving an input signal supplied from the FDC board 13. Meanwhile, the other end portion 13B of the FPC board 13 is provided with an FPC side terminal portion not shown) on one plate surface facing the array substrate 30.

The FPC side terminal portion is electrically connected to the FPC connection terminal portion through the ACF 50 arranged on the FPC connection terminal portion of the array substrate 30.

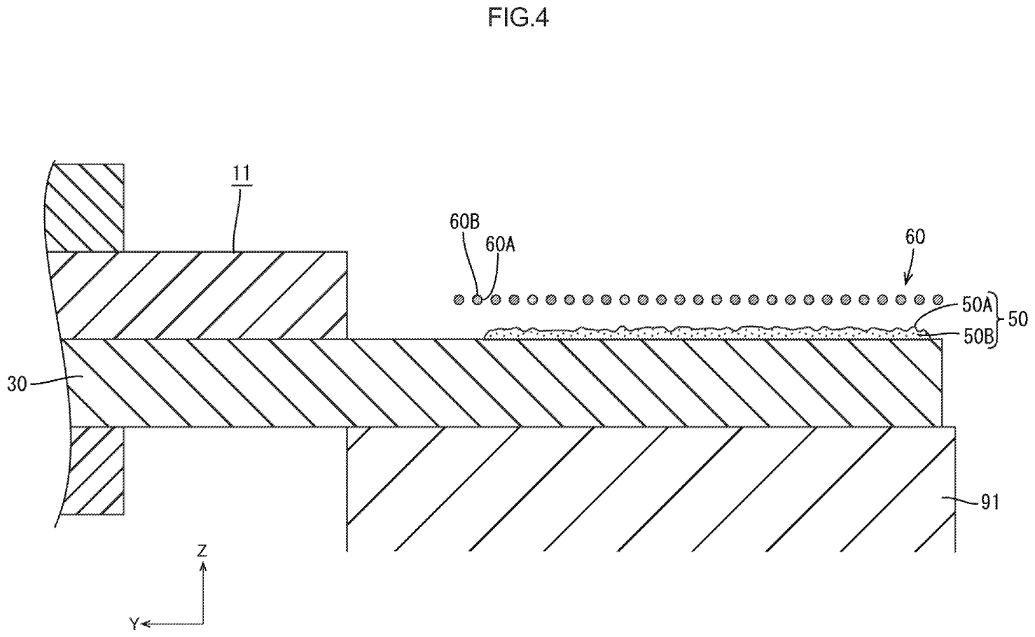

The ACF 50 includes an insulating thermosetting resin 50A, which is an adhesive and conductive particles 50B dispersed and blended in the thermosetting resin 50A. (see FIG. 4). Examples of the thermosetting resin 50A constituting the ACF 50 can include a phenoxy resin or an epoxy resin to which a curing agent is added. The ACF 50 is not particularly limited, and an anisotropic conductive adhesive “Three Bond 3370K” in which Ni/Au plated conductive particles having an average particle size of 5.0 μm are added to an epoxy resin and which is produced by Three Bond International, Inc can be used as an example. Three Bond 3370K is heated and pressed under conditions of 160° C. to 170° C., 20 seconds, and 2 MPa to 3 MPa to complete reliable curing.

In the present embodiment, the other end portion 13B of the FPC board 13 is pressed and connected to the FPC connection terminal portion of the array substrate 30 through the ACF 50, such that the conductive particles 50B are sandwiched and crushed between the FPC connection terminal portion and the FPC side terminal portion and conduction is thus achieved between the FPC connection terminal portion and the FPC side terminal portion.

The driver 12 has a horizontally long rectangular shape when viewed in a plane, and is arranged in a posture in which a long side direction thereof is along a short side direction of the array substrate 30 and a short side direction thereof is along the long side direction of the array substrate 30, as shown in FIG. 1. The driver 12 is arranged closer to the display area AA than to the FPC board 13 in the non-substrate overlapping area NSOA, and is connected to a position sandwiched between the substrate overlapping area SOA and the FPC board 13.

A mounting area of the driver 12 in the non-substrate overlapping area NSOA of the array substrate 30 is provided with a driver connection terminal portion (not shown) including an input terminal portion for supplying an input signal to the driver 12 and an output terminal portion for receiving an output signal from the driver 12. Note that the FPC connection terminal portion and the driver connection terminal portion are electrically connected by a relay line (not shown) formed so as to traverse between the mounting region of the FPC board 13 and the mounting region of the driver in the non-substrate overlapping region NSOA of the array substrate 30. Meanwhile, input side bumps and output side bumps protruding toward the array substrate 30 are provided on a surface of the driver 12 facing the array substrate 30 (all are not shown).

The input side bump and the output side bump are electrically connected to the input terminal portion or the output terminal portion of the driver connection terminal portion, respectively, through the ACF 50 arranged on the driver connection terminal portion of the array substrate 30. The ACF 50 is interposed between the array substrate 30 and the driver 12 so as to cover exposed surfaces of the input terminal portion and the output terminal portion and exposed surfaces of the input side bump and the output side bump without gaps.

In the present embodiment, the ACF 50 connecting the bumps of the driver 12 and the driver connection terminal portion of the array substrate 30 to each other is the same type of ACF as that of the ACF 50 electrically connecting the FPC connection terminal portion and the FPC side terminal portion described above to each other, such that all of types of thermosetting resin 50A and conductive particles SOB constituting the ACE' 50, and a content of the conductive particles 50B are the same as those of the ACF 50 described above. In addition, a conduction aspect between the driver connection input terminal portion and the input side bump and a conduction aspect between the driver connection output terminal portion and the output side bump are also the same as that between the FPC connection terminal portion and the FPC side terminal portion. That is, the driver 12 is pressed and connected to the array substrate 30 through the ACF 50, such that that the conductive particles 50B of the ACF 50 are sandwiched and crushed between the input terminal portion and the input side bump and between the output terminal portion and the output side bump and conduction between the driver connection terminal portion and the driver 12 is thus achieved.

However, the present technology can also be applied to a configuration in which the driver 12 and the FPC board 13 are connected to each other by different types of ACFs.

The liquid crystal module 1 having the configuration as described above is produced through a step of attaching the front polarizing plate 29 and the back polarizing plate 39 to front and back outer surface sides of the liquid crystal panel 11, respectively, and then sequentially connecting and fixing the driver 12 and the FPC board 13 to the non-substrate overlapping region NSOA of the array substrate 30 through the ACF 50. In a process of producing the liquid crystal module 1, a product inspection (an operation confirmation) is appropriately performed, and a semi-finished product to which the driver 12 and the FPC board 13 are connected is also inspected by, for example, a lighting inspection. Here, when a defect such as a lighting defect or the like is confirmed, the semi-finished product is excluded from a normal producing step as an unsuitable product. By further performing an inspection on the semi-finished product considered as the unsuitable product and detaching and replacing a component in which a defect such as an operation defect due to damage or the like of the driver 12 or the FPC board 13, a processing defect due to positional deviation at the time of connection, or the like, occurs, semi-finished products are classified into a semi-finished product in which reuse, that is, rework (repair) of members other than the corresponding component is possible and a semi-finished product in which the rework of the members other than the corresponding component is impossible. The semi-finished product in which the rework is possible is a target of rework (repair).

Next, rework of the semi-finished product of the liquid crystal module 1 will be described.

The unsuitable products that are the targets of rework are generated in a product inspection related to each producing step of the liquid crystal module 1, but rework of a semi-finished product 1A of the liquid crystal module 1 which is determined to be unsuitable in a product inspection related to a connection step of the driver 12 and the FPO board 13 and in which a defect based on internal line defects or the like of the driver 12 and the FPC board 13 is confirmed will hereinafter be described.

As shown in FIG. 2, first, the driver 12 and the FPC board 13 that are targets to be replaced are detached from the array substrate 30.

Here, fixed places of the driver 12 and the FPC board 13 on the array substrate 30 are heated to a temperature at which the ACF 50 connecting the driver 12 and the FPC board 13 to each other is melted, for example, 160° C. or more to detach the driver 12 and the FPC board 13. The heating for melting the ACF 50 may be performed from a side (a front side) adjacent to the driver 12 and the FPC board 13 or may be performed from a side (a back side) adjacent to the array substrate 30, depending on a situation. Alternatively, the heating for melting the ACF 50 may be performed from both sides. However, it is preferable that partial cooling or heat shielding is appropriately performed such that normal members such as the polarizing plates 29 and 39 or the liquid crystal layer are not affected by the heating. In the present embodiment, a case where two electrical components such as the driver 12 and the FPC board 13 are detached and replaced is exemplified, but in a case where only one of the two electrical components is replaced, it is preferable that the electrical part that is not a target to be replaced is similarly protected. Note that the driver 12 and the FPC board 13 need not be detached in accordance with the heating, and may be configured to be detached by applying, for example, an external force.

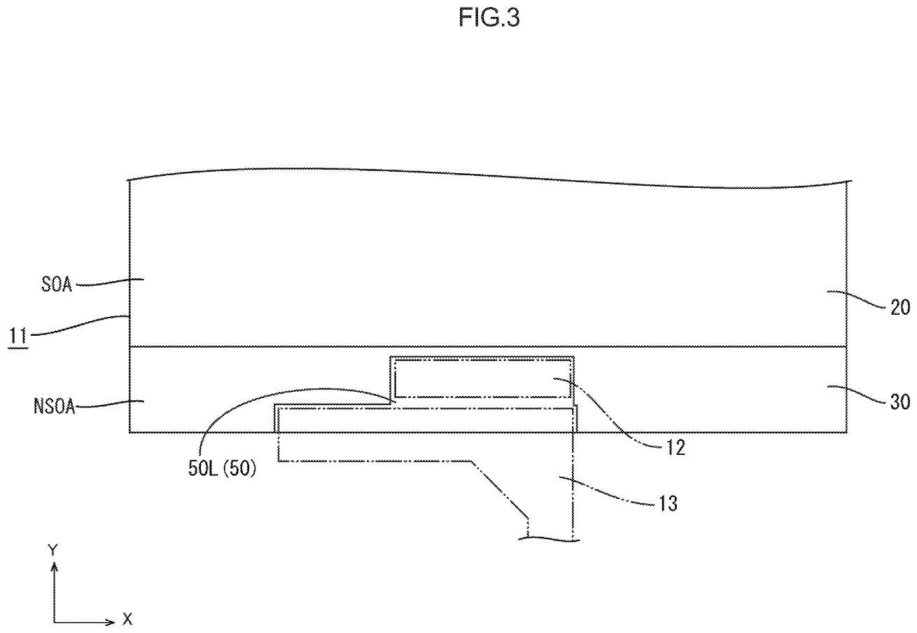

As shown in FIG. 3, after the driver 12 and the FPC board 13 are detached from the array substrate 30, the ACF 50 that has adhered the driver 12 and the FPC board 13 to the array substrate 30 remains a residual layer 50L at these fixed places on the array substrate 30. When the array substrate 30 is reused with the residual layer 50L attached to the array substrate 30, a new driver 12 and FPC board 13, which are good products, are not fixed well to the array substrate 30, and it is highly likely that a connection defect will occur in the liquid crystal module 1 produced using the new driver 12 and FPC board 13. For this reason, removal of the residual layer 50L on the array substrate 30 is performed after the detachment of the driver 12 and the FPC board 13. Since the ACF 50 is firmly attached to the array substrate 30 and thus, it is not easy to remove the residual layer 50L, in the present embodiment, a method and a device are devised to efficiently remove the residual layer 50L of the ACF 50 from the array substrate 30.

The removal of the residual layer 50L will be described.

In the present embodiment, the residual layer 50L is removed by a residual layer removal method including an arranging step, a heating pressing step (a heating step and pressing step), and a peeling step. It is preferable that the removal of the residual layer 50L is performed using a residual layer removal device including a mechanism required for removing the residual layer 50L. A residual layer removal device according to the present embodiment includes a base 91, a heating pressing mechanism (a heating mechanism and pressing mechanism) 92, and a peeling mechanism (not shown). The base 91, the heating pressing mechanism 92, and the peeling mechanism may be manually operated individually, or the residual layer removal device may further include a control mechanism that controls the base 91, the heating pressing mechanism 92, and the peeling mechanism in conjunction with one another.

Hereinafter, respective steps related to the removal of the residual layer 50L will be sequentially described.

FIGS. 4 to 8 are cross-sectional views schematically showing states of the respective steps related to a removal method of the residual layer 50L in the present embodiment.

In the arranging step, a metal mesh (a metal wire woven fabric and an example of a metal porous material) 60 is arranged on a surface of the residual layer 50L.

As shown in FIG. 4, in the present embodiment, first, the liquid crystal panel 11 in which the residual layer 50L is attached to the array substrate 30 is placed on the base 91. The base 91 according to the present embodiment is a stable fixed stand formed of a material having a high heat resistance, such as a metal plate or the like. It is preferable that the liquid crystal panel 11 is fixed so as not to move in a horizontal direction by forming protrusions depending on an appearance of the liquid crystal panel 11 on an upper surface of the base 91. Note that the base 91 may be configured to partially or wholly raise a temperature or ascend and descend so as to have a heating or pressing function.

Next, the metal mesh 60 is arranged from a front side of the liquid crystal panel 11 on the base 91 so as to cover a surface of the residual layer 50L attached to the array substrate 30. The metal mesh 60 may be arranged by moving a movable arm or the like that holds the metal mesh 60, or may be manually arranged at a predetermined place by a worker. Note that the metal mesh 60 arranged in the present step will be described in detail later.

In the heating step, heating is performed in order to soften the residual layer 50L, and in the pressing step, the metal mesh 60 arranged on the surface of the residual layer 50L by the arranging step is pressed to the residual layer 50L softened by the heating step. Thus, at least parts of the ACF 50 constituting the residual layer 50L are press-fitted into open holes 60A of the metal mesh 60. In the present embodiment, the heating step and the pressing step are conducted as a simultaneously performed heating pressing step (a heating step and pressing step).

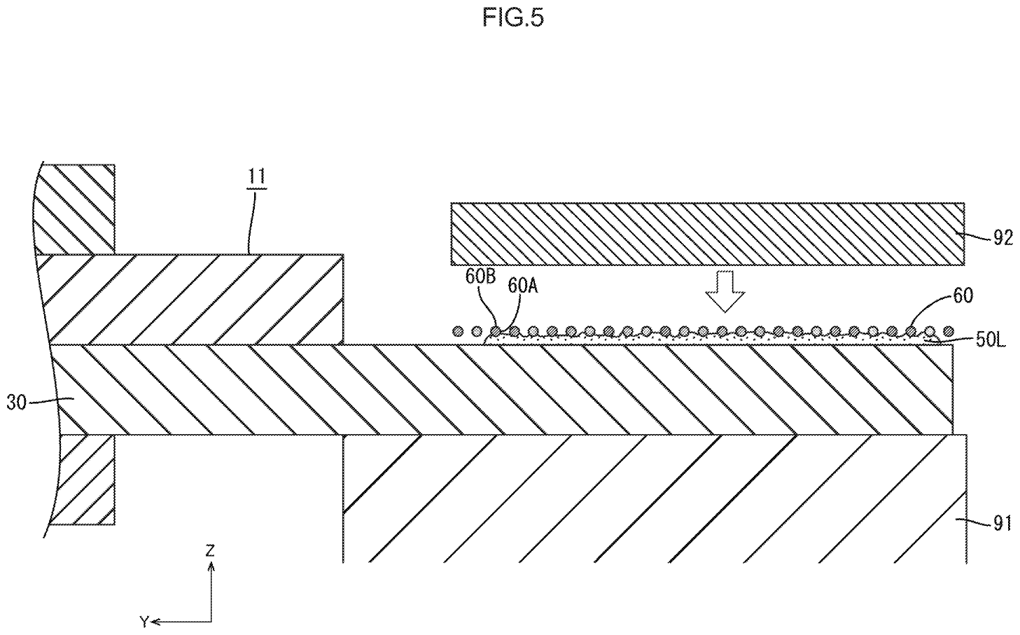

As shown in FIG. 5, in the present embodiment, the heating pressing mechanism 92 whose temperature is raised to a predetermined temperature approaches and is brought into close contact with a front side of the metal mesh 60 arranged on the surface of the residual layer 50L. The heating pressing mechanism 92 according to the present embodiment has a heating unit that can be set to raise a temperature to a predetermined temperature and is formed to be ascend and descend by a motor, pressed gas or the like, such that the heating pressing mechanism 92 descends to a surface of the array substrate 30 or the like on the fixed base 91 to press the surface of the metal mesh 60 at a predetermined pressure for only a predetermined time by the heating unit maintained at the predetermined temperature.

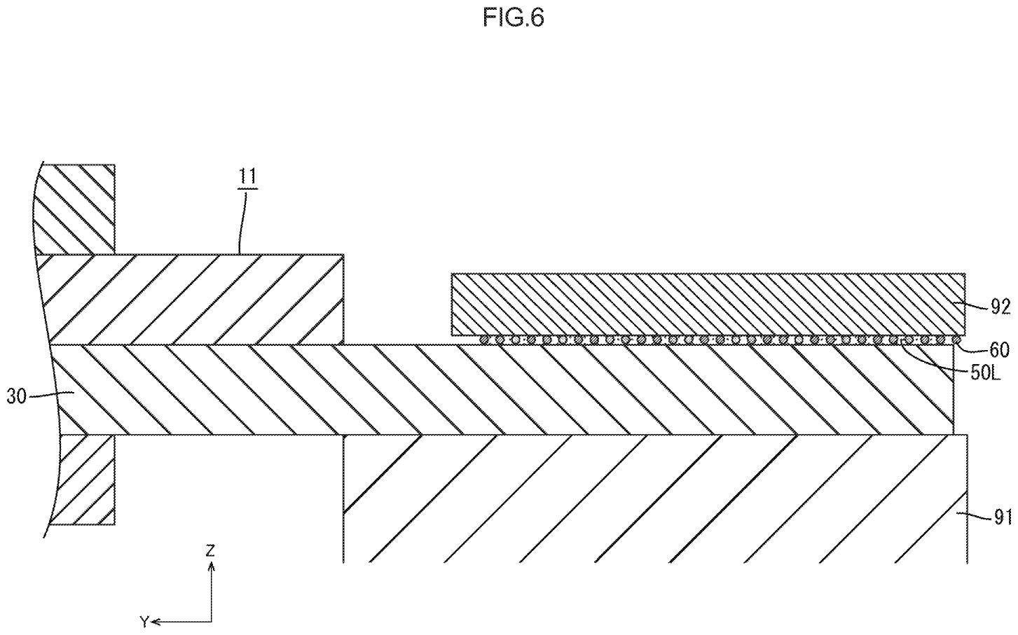

As shown in FIG. 6, as the heating pressing mechanism 92 whose temperature is sufficiently raised descends, as the heating pressing mechanism 92 comes into contact with the surface of the metal mesh 60 or the like to heat and soften the residual layer 50L and push the metal mesh 60 into the surface of the softened residual layer 50L. Thus, at least parts of the ACF 50 constituting the residual layer 50L are press-fitted into the open holes 60A of the metal mesh 60. In the present embodiment, the heating pressing mechanism 92 descends until metal wires 60B constituting the metal mesh 60 come into contact with the surface of the array substrate

A set value such as a heating temperature, a pressing force or the like at the time of the heating pressing is appropriately selected depending on a structure or a configuration of the liquid crystal panel 11 or the like provided in the present step, structures or configurations of the metal mesh 60 and a jig or the like including the metal mesh, a work environment, and the like, as well as a thermal property or an adhesion state of the ACF 50 constituting the residual layer 50L. Note that since a state of the residual layer 50L is changed in the vicinity of 160° C. when the residual layer 50L formed of Three Bond 3370K described above is heated and the residual layer 50L is softened in a jelly shape as a temperature further rises, in a case of using Three Bond 3370K as a material of The ACF 50, it is sufficient if the heating unit whose temperature is raised to, for example, 160° C. to 200° C. is pressed at a pressure of 2 MPa to 3 MPa for 20 seconds to 60 seconds. Note that the heating of the residual layer 50L is not necessarily performed from the front side, and may be performed from the back side of the array substrate 30 by raising a temperature of the base 91 in some cases. The residual layer 50L may be heated from both of the front side and the back side.

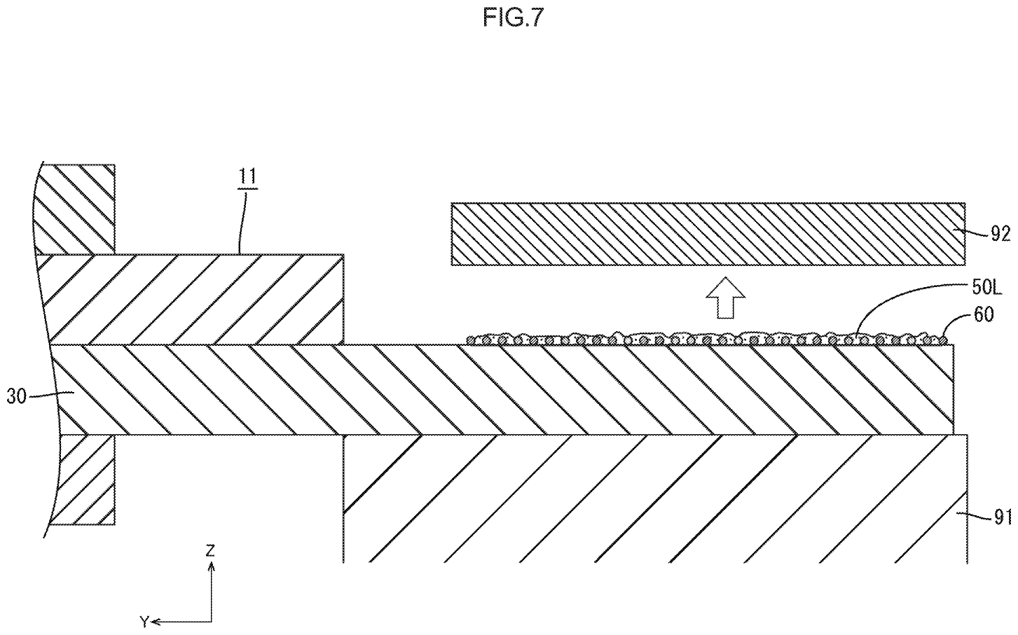

As shown in FIG. 7, after The heating pressing, the heating pressing mechanism 92 is raised to end the heating and the pressing. Thus, the temperature of the residual layer 50L is lowered, and the ACF 50 constituting the residual layer 50L enters the open holes 60A and is hardened in a state where it is entangled with the metal wire 60B.

The peeling step is performed after the heating pressing step, and the metal mesh 60 in which the ACF 50 is press-fitted into the open holes 60A is peeled off from the array substrate 30 by the peeling mechanism.

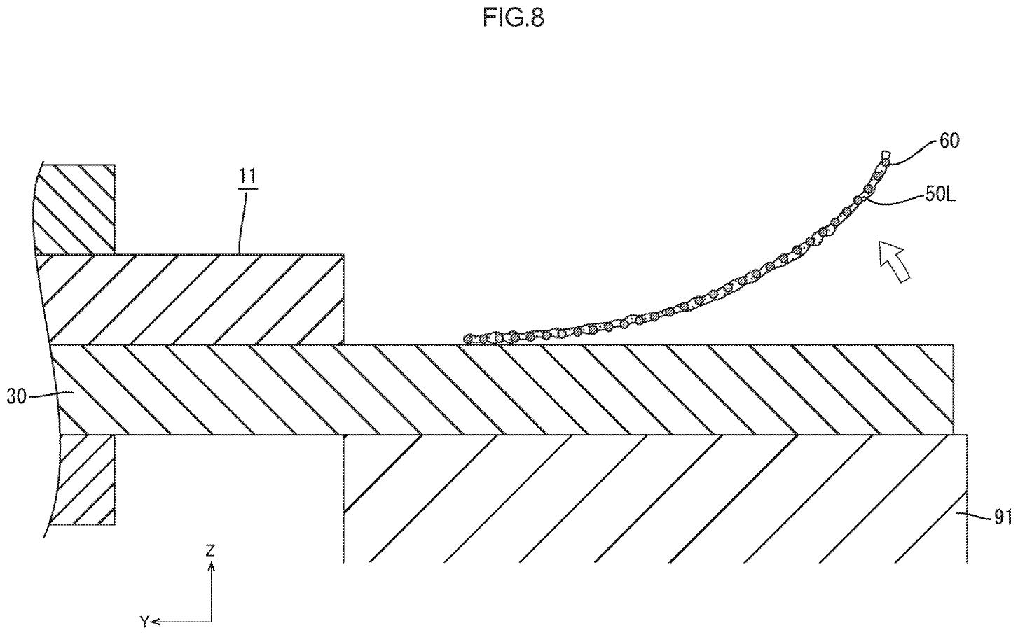

As shown in FIG. 8, it is preferable that the metal mesh 60 is peeled off so as to be stripped from the array substrate 30. In other words, it is preferable that the metal mesh 60 is peeled off such that not only an external force perpendicular to an adhesion surface between the residual layer 50L and the array substrate 30 acts, but an oblique external force also acts. Although not shown, the peeling mechanism can be driven using a rotation arm, a rotating roll-like member or the like. For example, a peeling mechanism or the like disclosed in Japanese Unexamined Patent Application Publication No. 2001-199626 may be applied. Further, whether or not to heat the residual layer 50L in the peeling step can be appropriately determined depending on a thermal property of the ACF 50, a shape of the metal mesh 60, or the like. For example, the heating is performed from the front side or both sides until the pressing step, and switching may be conducted such that the heating is performed from the back side only in the peeling step.

By the present step, as described in detail later, the residual layer 50L attached to the array substrate 30 is removed together with the metal mesh 60.

The metal mesh 60 used in the present embodiment will be described in detail.

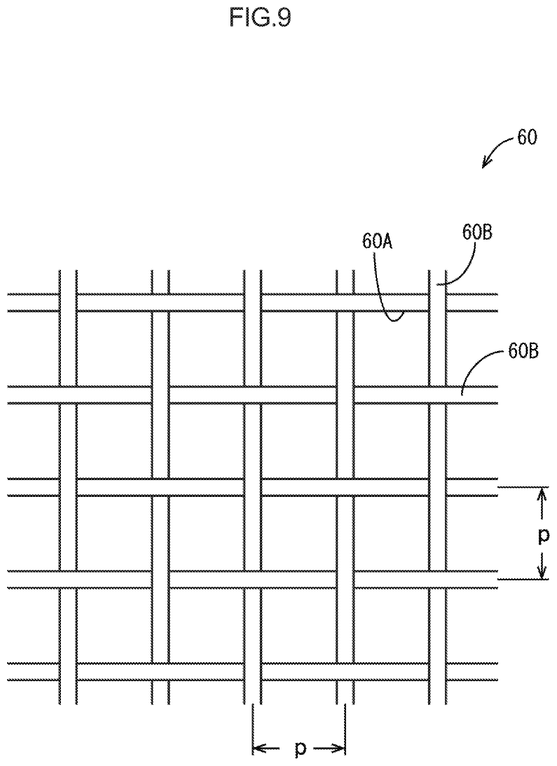

As shown in FIG. 9, in the metal mesh 60, which is a knitted fabric having a structure in which the metal wires 60B are knitted, a planar body formed in a planar shape can be used. As shown in FIG. 4 and the like, in the present embodiment, the metal mesh 60 having a single layer structure is used.

A metal constituting the metal mesh 60 is not particularly limited, but it is preferable that the metal mesh 60 is formed of a metal having a heat-resistant temperature higher than a heating temperature (for example, 160° C. to 300° C.) at the time of the heating pressing since it is pressed to the ACF 50 of the residual layer 50L heated and melted as described later. For example, copper, aluminum or the like can be used in addition, since the metal mesh 60 is bitten into the residual layer 50L and then peeled off, a material having strength enough to endure these operations is used.

It is preferable that a porous structure of the metal mesh 60 is formed of a woven fabric, a knitted fabric or the like having a structure in which the metal wires 60B are knitted, rather than a punching metal or the like formed by perforating a metal plate from the viewpoint of facilitating the press-fitting the ACF 50 into the open holes 60A and from the viewpoint of obtaining a large adhesive force between the press-fitted ACF 50 and the metal mesh 60. A knitted structure is not particularly limited. In the present embodiment, as shown in FIG. 9, a metal mesh 60 formed of a woven fabric in which the metal wires 60B are plain-woven is used, but a woven fabric such as, for example, a twill woven fabric, a Tatami woven fabric or the like may be used or a knitted fabric having various knitted structures may be used. It is preferable to select having a fabric having an appropriate structure in consideration of porosity or strength (stretchability), a surface structure, and the like. In addition, in connection with this, a shape of an open hole on an interface between the metal mesh 60 and the residual layer 50L is not particularly limited. In the present embodiment, as shown in FIG. 9, an open hole having a square shape is used, but open holes having various polygonal shapes such as a rhombic shape, a parallelogram shape, a rectangular shape, and a triangular shape can be used.

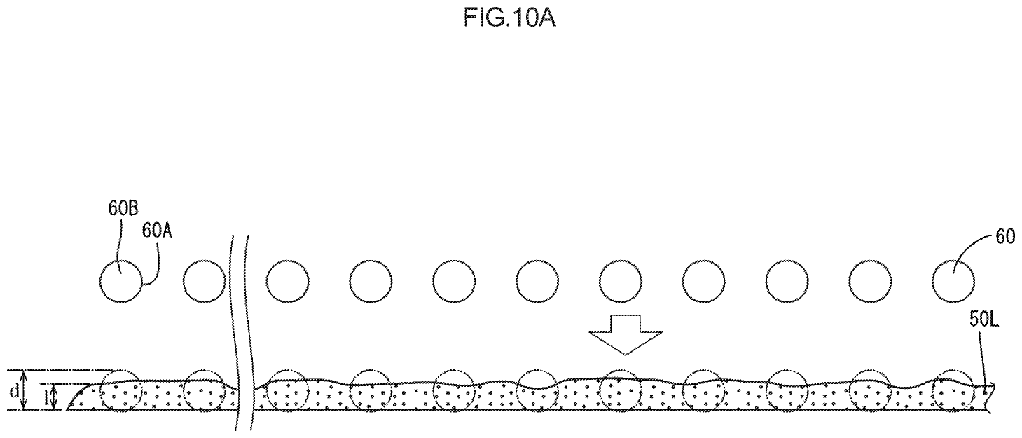

A cross-sectional shape of the metal wires 60B forming the knitted fabric or the like is not particularly limited. In the present embodiment, as shown in FIG. 10A and the like, the cross-sectional, shape of the metal wires 60B is a substantially circular shape, but is not limited thereto, and various shapes such as an elliptical shape, a triangular shape, a star shape, or the like, can be used.

A wire diameter of the metal wires 60B forming the knitted fabric or the like is not particularly limited, but is preferably selected appropriate depending on a layer thickness of the residual layer 50L that is the target to be removed. In order to increase an adhesive force between the ACF 50 and the metal mesh 60, as described later, it is preferable that the ACF 50 press-fitted into the open hole 60A comes into contact with an outer peripheral surface of the metal wire 60B as much as possible and the ACF reaches a surface layer side of the metal mesh 60 to wrap the metal wires 60B. For example, in a case where the residual layer 50L is a thin layer having an average layer thickness (1 in FIG. 10A) of about 25 μm, a diameter (d in FIG. 10A) of the metal wire 60B is preferable 50 μm or less (d≤21), and more preferably 25 μm or less (d≤1). In a case where the residual layer 50L having a large layer thickness is a target to be removed, a thick metal wire 60B having a diameter of about 50 μm or 100 μm can be used. In the present embodiment, the metal wire 60B having a diameter d satisfying 1≤d≤21 is used.

An effect cannot be exerted if an open hole pitch (p in FIG. 9) of the open hole 60A of the metal mesh 60 is too narrow or too wide from the viewpoint of subdividing an adhesion surface of the residual layer 50L with the array substrate 30 as described later. Therefore, the adhesive force between the ACF 50 of the residual layer 50L and the metal mesh 60 is appropriately selected so as to be larger than the adhesive force between the same ACF 50 and the array substrate 30.

A mechanism by which the residual layer 50L attached to the array substrate 30 is removed together with the metal mesh 60 by each of the above steps will he described with reference to FIGS. 10A and 10B.

FIG. 10A is an image view showing an enlarged cross section of the residual layer 50L before the heating pressing step, and FIG. 10B is an image view showing an enlarged cross section of the residual layer 50L after the heating pressing step. Note that in both of FIGS. 10A and 10B, a back surface (a lower side in the drawings) of the residual layer 50L is the adhesion surface with the array substrate 30.

In the present embodiment, the residual layer 50L formed of the ACF 50 is the target to be removed. As shown in (A), before the heating pressing step, the residual layer 50L is formed in an integral lump shape, and is adhered to the array substrate 30 on a continuous large adhesion surface. When the metal mesh 60 arranged so as to cover the surface of the residual layer 50L in the arranging step is pressed to the residual layer 50L while being heated together with the residual layer 50L in the heating pressing step, the ACF 50 constituting the residual layer 50L softened by the heating enters the open holes 60A of the metal mesh 60. Thus, the ACF 50 comes into contact with the metal wires 60B around outer peripheries of the metal wires 60B, such that the residual layer 50L is in a state in which it is entangled with the metal mesh 60. When adhesion areas between the ACF 50 and the metal wires 60B are increased, an adhesive force between the residual layer 50L and the metal mesh 60 is increased accordingly, such that it becomes difficult for the residual layer 50L to be separated from the metal mesh 60.

When the metal mesh 60 is further pressed, such that the metal wires 60B forming the open holes 60A comes into contact with the surface of the array substrate 30, as shown in (B), the residual layer 50L having the lump shape is divided by the metal wires 60B of the metal mesh 60, such that the adhesion surface between the residual layer 50L, and the array substrate 30 is subdivided. When the adhesion surface is subdivided, such that each adhesion area is reduced, the adhesive force between the residual layer 50L, and the array substrate 30 is reduced accordingly, such that it becomes easy for the residual layer 50L to be peeled off from the array substrate 30.

Then, when the heating ends in a state where the ACF 50 is press-fitted into the open holes 60A, most of the ACF 50 is fixed in accordance with a decrease in temperature in a state where it is entangled with the metal wires 60B of the metal mesh 60. In the present embodiment, since the metal wires 60B having the diameter d satisfying 1≤d≤21 are used, the ACF 50 is press-fitted up to a surface layer side beyond the narrowest portions (positions where a distance between adjacent metal wires 60B is the shortest) of the open holes 60A. Therefore, it becomes difficult for the residual layer 50L and the metal mesh 60 be separated from each other also by an anchor effect of the ACF 50 hardened in accordance with the decrease in temperature.

As a result, the adhesive force between the residual layer 50L and the metal mesh 60 can be made larger than the adhesive force between the residual layer 50L and the array substrate 30. Therefore, the residual layer 50L can be peeled off together with the metal mesh 60 by stripping the metal mesh 60 from the array substrate 30.

The liquid crystal module 1 can be produced using the liquid crystal panel 11 including the array substrate 30 regenerated by removing the residual layer 50L as described above.

For example, the liquid crystal module 1 as shown in FIG. 1 is produced by newly arranging an ACF 50 at a predetermined position of the regenerated array substrate 30 and connecting and fixing a new driver 12 and FPC board 13, which are good products.

As described above, according to the present embodiment, the residual layer 50L of the ACF 50 attached to the array substrate 30 used in the liquid crystal module 1 is efficiently removed.

According to the method of the present embodiment, at least parts of the ACF 50 constituting the residual layer 50L softened by the heating are press-fitted into the open holes 60A of the metal mesh 60, such that the adhesion areas between the ACF 50 and the metal wires 60B are increased and the adhesive force between the residual layer 50L and the metal mesh 60 can thus be made larger than the adhesive force between the residual layer 50L and the array substrate 30. Thus, by stripping the metal mesh 60 from the array substrate 30, the residual layer 50L can be entangled with the metal mesh 60 to be removed from the array substrate 30. Since the metal mesh 60 is formed of a metal having an excellent heat resistance, the pressing step or the peeling step can be stably performed on the metal mesh. As in the present embodiment, in a configuration in which the heating pressing mechanism 92 heats the residual layer 50L through the metal mesh 60, the residual layer 50L can be efficiently heated by the metal wires 60B formed of a metal having a high thermal conductivity. In the peeling step, it is sufficient if the metal mesh 60 having an excellent mechanical strength is peeled off. Therefore, a work can be easily performed, and damage to the array substrate 30 when removing the residual layer 50L is suppressed, such that a breakage rate (a failure rate) can be reduced. In addition, a variation caused by workers is reduced, and it is possible to realize a device, such that efficiency of a work of removing the residual layer 50L is further improved.

In the heating pressing step according to the present embodiment, the metal wires 60B forming the open holes 60A of the metal mesh 60 is pressed so as to come into contact with the array substrate 30.

Thus, the residual layer 50L having the lump shape is finely divided by the metal wires 60B of the metal mesh 60, such that an adhesion area between the residual layer 50L and the array substrate 30 is reduced. Accordingly, an adhesive force is reduced, such that it becomes easy to peel off the residual layer 50L from the array substrate 30.

In addition, the metal mesh 60 used in the present embodiment is a planar body having a knitted structure formed by the metal wires 60B.

In the metal mesh 60 formed by knitting the metal wires 60B, it is easier for open hole edges to be cut into the residual layer 50L than in a metal porous material formed by perforating a metal plate. Thus, the adhesion area between the metal mesh 60 and. the residual layer 50L is increased, such that a large adhesive force is obtained, and it becomes thus easy to peel off the residual layer 50L from the array substrate 30 together with the metal mesh 60. In addition, the metal mesh 60 which is the planar body can be easily pressed to the residual layer 50L or peeled off from the array substrate 30, which is advantageous in stripping the residual layer 50L together with the metal mesh 60 at the time of performing the peeling.

The metal wires 60B forming the metal mesh 60 used in the present embodiment have the diameter d larger than the average layer thickness 1 of the residual layer 50L and smaller than two times (1≤d≤21) the average layer thickness 1 of the residual layer 50L.

In the present embodiment, the heating pressing mechanism 92 is configured to come into contact with the metal mesh 60 from the front side and push the metal wires 60B into the residual layer 50L, but by setting 1≤d, the metal wires 60B can be brought into contact with the array substrate 30 only by lowering the heating pressing mechanism 92 as it is. In addition, by setting d≤21, the ACF 50 is press-fitted so as to wrap around up to the surface layer side beyond the narrowest portions of the open holes 60A by the pressing step. Therefore, the adhesion areas between ACF 50 and metal wire 60B are increased, and the anchor effect by the ACF 50 hardened by the end of the heating is obtained, such that it becomes more difficult for the residual layer 50L and the metal mesh 60 to be separated from each other. Therefore, it becomes easy to peel off the residual layer 50L from the array substrate 30 together with the metal mesh 60.

As shown in the present embodiment, the present technology can be particularly preferably applied when the array substrate 30 is regenerated by removing the residual layer 50L of the ACF 50 connecting and fixing the driver 12 and the FPC board 13 onto the array substrate 30.

If the residual layer removal device according to the present embodiment is used, it possible to efficiently remove the residual layer 50L of the ACF 50 attached to the array substrate 30 while reducing a failure rate or stabilizing a work and shortening a work time in regenerating the array substrate 30.

By producing the liquid crystal module 1 using the regenerated array substrate 30 as in the present embodiment, it is possible to achieve cost reduction of the liquid crystal module 1. in addition, by using the regenerated array substrate 30 from which the residual layer 50L of the ACF 50 is removed with a high probability, it is possible to reduce occurrence of a defect due to the regenerated array substrate 30 in the liquid crystal module 1.

### Second Embodiment

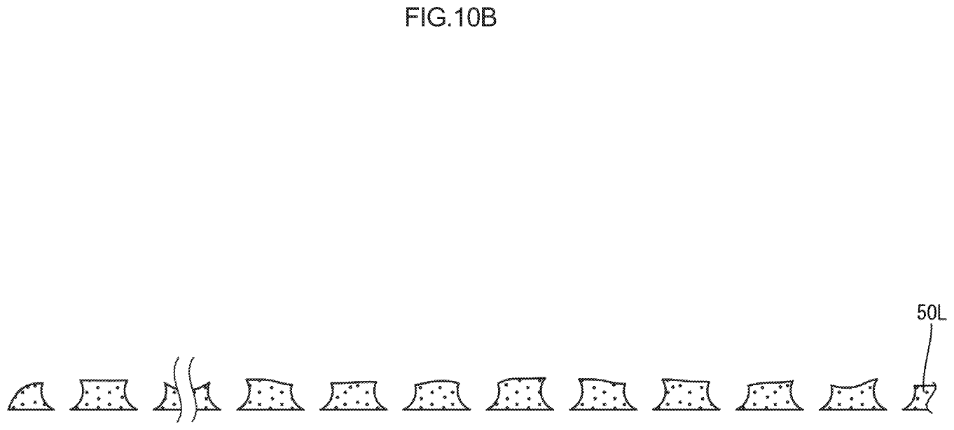

A second embodiment will be described with reference to FIG. 11. In the second. embodiment, a structure of a metal mesh is different from that of the first embodiment. Hereinafter, an overlapping description of the same configuration, action, and effect as those of the first embodiment described above will be omitted (the same applies to a third embodiment).

FIG. 11 is a view schematically showing a cross-sectional configuration of a metal mesh 260 according to the second embodiment together with a cross section of a residual layer 250L that is a target to be removed. The metal mesh 260 according to the second embodiment is a multilayer planar body in which a structure in which metal wires 260B are knitted is formed in multiple layers. The metal wires 260B forming the metal mesh 260 used in the present embodiment have a diameter d smaller than an average layer thickness 1 of the residual layer 250L (d≤1).

According to the configuration of the second embodiment, since volumes of voids into which an ACF can be press-fitted are increased in a thickness direction of the metal mesh 260, a thicker residual layer can be removed. Alternatively, in a case where a layer thickness of the residual layer 250L is small, the same metal mesh 260 can be used repeatedly multiple times. In addition, by setting d≤1, the metal mesh 260 can be pushed into the residual layer 250L such that at least the metal wires 260B on a side in contact with the residual layer 250L are wrapped in the ACF. Thus, the ACF enters voids of the knitted structure of the metal mesh 260 in a complicated shape, such that adhesion areas are increased, and a large anchor effect is obtained by the ACF solidified in a state where the ACF enters the metal mesh 260. As a result, it becomes more difficult to separate the residual layer 250L and the metal mesh 260 from each other. Therefore, it becomes more difficult to peel off the residual layer 250L and the metal mesh 260 together with each other. Further, even though d≤1, the entire thickness of the metal mesh 260 is larger than a layer thickness of the residual layer 250L. Therefore, in the heating pressing step, by pressing the metal mesh 250 from a front side to the residual layer 250L as it is as in the first embodiment, it is possible to bring the metal wires 260B into contact with a surface of a substrate. Note that the same effect as that of the metal mesh 260 can be obtained even though planar bodies having a single-layer knitted structure are used in an overlapping manner as the metal mesh.

### Third Embodiment

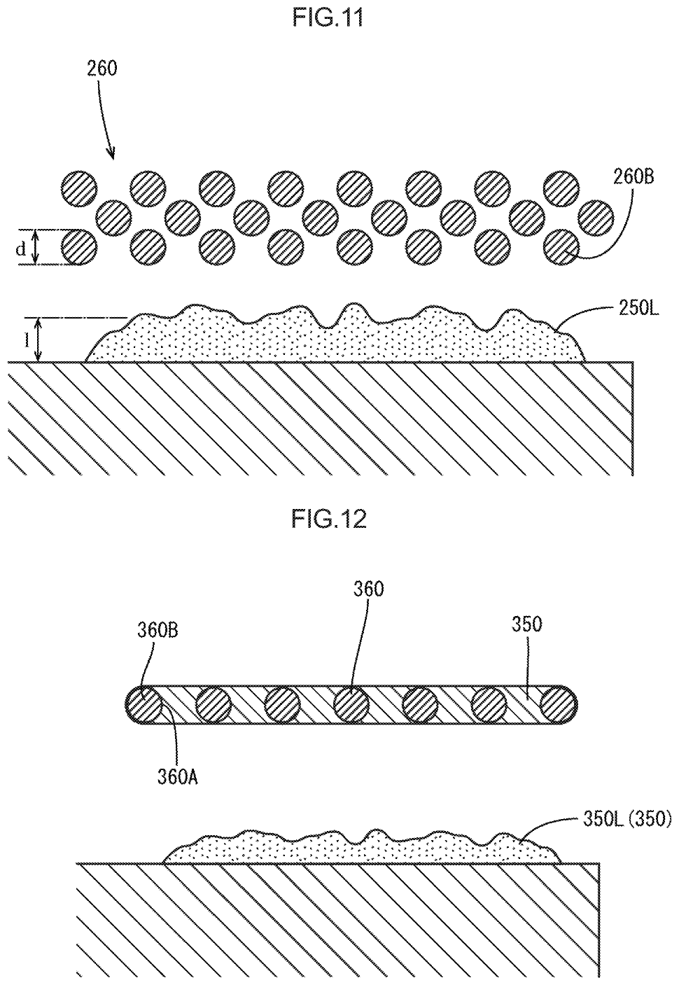

A third embodiment will be described with reference to FIG. 12. Also in the third embodiment, a structure of a metal mesh is different from that of the first embodiment.

FIG. 12 is a view schematically showing a cross-sectional configuration of a metal mesh 360 according to a third embodiment. In the metal mesh 360 according to the present embodiment, at least parts of surfaces of open holes 360A, that is, outer peripheral surfaces of metal wires 360B are covered with the same resin as that of a residual layer 350L formed of an ACF 350, that is, the ACF 350. Note that a resin having surface energy close to an adhesive resin, such as a resin containing the same kind of functional group as that of the adhesive resin, can be used as a covering resin having an excellent affinity with the adhesive resin. In addition, as the metal mesh 360, a metal mesh 360 in which the metal wires 60B are coated with the ACF 350 can be used. Alternatively, a resin film may be inserted into the metal mesh or a resin gel may be applied to the metal mesh.

According to the configuration of the third embodiment, the coating resin formed of the same ACE 350 as that of the residual layer 350L is interposed on the surfaces of the open holes 360A of the metal mesh 360, such that an adhesive force between the residual layer 350L and the metal mesh 360 is increased, and it becomes thus easy for toe ACF 350 of the residual layer 350L to be attached to the metal mesh 360. As a result, it becomes difficult for the residual layer 350L to be separated from the metal mesh 360, such that the residual layer 350L can be removed with a higher probability.

### Fourth Embodiment

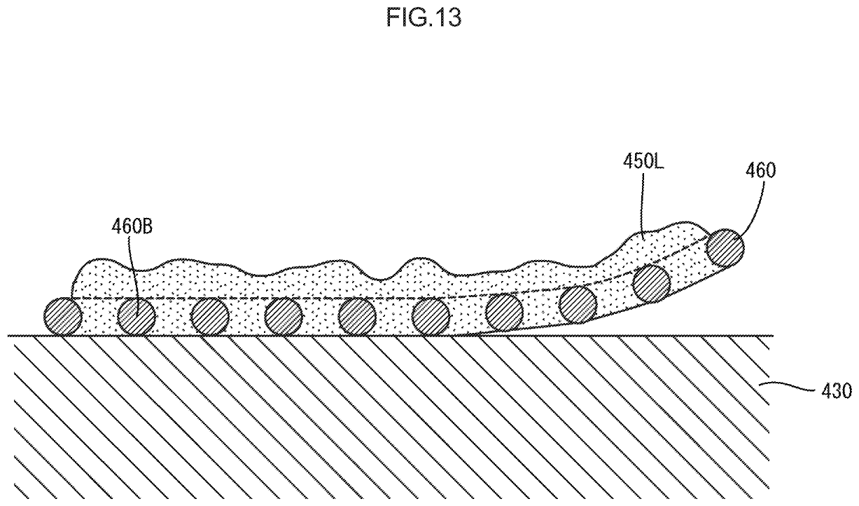

A fourth embodiment will be described with reference to FIG. 13. The fourth embodiment is different from the first embodiment in that the present technology is applied to removal of an adhesive layer adhering a liquid crystal panel to a frame of a backlight device in a liquid crystal module including the backlight device.

FIG. 13 is a view schematically showing a state of heating pressing a metal mesh 60 to a residual layer 450L formed of a hot melt adhesive attached to a frame 430 of a backlight device and having a large thickness and then peeling off the metal mesh and the residual layer from the frame 430. Metal wires 460B forming the metal mesh 460 used in the present embodiment have a diameter d smaller than an average layer thickness 1 of the residual layer 450L (d≤1) The metal mesh 460 according to the fourth embodiment has a single layer structure, and the entire thickness of the metal mesh 460 is also smaller than the average layer thickness 1 of the residual layer 450L. Therefore, in the fourth embodiment, a metal mesh having an area sufficiently larger than that of the residual layer 450L may be used as the metal mesh 460, and, for example, a peripheral edge portion of the metal mesh that does not overlap the residual layer 450L may be pressed to bite the metal mesh into the residual layer 450L and press the metal mesh until it comes into contact with the frame 430. In this case, it is preferable that a heating mechanism and a pressing mechanism are constituted by separate members. For example, a configuration in which only the pressing mechanism is lowered to push the metal mesh 460 downward while the heating mechanism is brought into contact with a surface of the residual layer 450L and heats the residual layer 450L, a configuration in which the residual layer 450L is heated from the frame 430, or a configuration in which the residual layer 450L is heated in a non-contact state by an electron beam or the like can be considered.

According to the configuration according to the fourth embodiment, it is possible to efficiently remove not only a relatively thin residual layer formed of the ACF but also a relatively thick residual layer 450L formed of the hot melt adhesive without increasing the entire thickness of the metal mesh 460.

### Other Embodiments

The present technology is not limited to the embodiments described with reference to the above description and drawings, and, for example, the following embodiments are also included in the technical scope of the present technology.

(1) As a metal porous material, in addition to the metal meshes exemplified in each of the embodiments described above, metal porous materials having various structures can be used. As shown in each embodiment, it is preferable that the metal porous material has a knitted structure formed of metal wires, but is not limited thereto, and it is sufficient if the metal porous material is a planar body including holes into which at least parts of an adhesive resin constituting a residual layer can be press-fitted by forming open holes in a surface.

(2) According to the present technology, it is possible to efficiently remove not only the ACF or the hot melt adhesive exemplified in each of the embodiments described above, but also residual layers of various adhesive resins softened by heating.

(3) According to the present technology, it is possible to remove not only a hard substrate such as the array substrate of the liquid crystal panel and the frame of the backlight device exemplified in the embodiments described above, but also a residual layer of an adhesive resin attached to a soft substrate. For example, the present technology is also effective in removing a flexible substrate included in an FPC board or a residual layer of an ACF attached to a film substrate of a chip on film (COF). (4) The present technology can be widely applied to removal of a residual layer from a substrate for a display module including an organic electro luminescence (EL) panel, a plasma display panel or the like as a display panel as well as the liquid crystal module including the liquid crystal panel exemplified in the embodiment described above.

### EXPLANATION OF SYMBOLS

1: Liquid crystal module (Example of display module)

11: Liquid crystal panel

12: Driver (Example of electrical component)

13: FPC board (Example of electrical component)

14: Control board

20: CF substrate

30: Array substrate (Example of substrate)

50: ACE (Example of adhesive resin)

50L, 250L, 350L, 450L: Residual layer

60, 260, 360, 460: Metal mesh (Metal wire woven fabric and example of metal porous material)

60A, 360A: Open hole

60B, 260B, 360B, 460B: Metal wire

91: Ease

92: Heating pressing mechanism (Heating mechanism and pressing mechanism)

d: Diameter of metal wire

1: Average layer thickness of residual layer

1. A residual layer removal method of removing a residual layer of an adhesive resin attached to a substrate used in a display module, the residual layer removal method comprising:
an arranging step of arranging a metal porous material on a surface of the residual layer;
a heating step of heating and softening the residual layer;
a pressing step of pressing the metal porous material arranged on the surface of the residual layer by the arranging step to the residual layer softened by the heating step to press-fit at least parts of the residual layer into open holes of the metal porous material; and
a peeling step of peeling off the metal porous material in which the residual layer is press-fitted into the open holes from the substrate.

2. The residual layer removal method according to claim 1, wherein, in the pressing step, the metal porous material is pressed such that opening hole edges of the metal porous material come in contact with the substrate.

3. The residual layer removal method according to claim 1, wherein the metal porous material is a planar body having a knitted structure formed of metal wires.

4. The residual layer removal method according to claim 3, wherein each of the metal wires has a diameter smaller than an average layer thickness of the residual layer.

5. The residual layer removal method according to claim wherein the metal porous material is a multilayer planar body having a multilayer knitted structure formed of metal wires.

6. The residual layer removal method according to claim 1, wherein at least parts of surfaces of the open holes of the metal porous material are coated with a coating resin having an excellent affinity with the adhesive resin.

7. The residual layer removal method according to claim 1, wherein the substrate is a substrate in which an electronic circuit is formed in the substrate, and the adhesive resin is an anisotropic conductive adhesive that connects and fixes an electrical component on the substrate.

8. A residual layer removal device of removing a residual layer of an adhesive resin attached to a substrate used in a display module, the residual layer removal device comprising:
a base on which the substrate is arranged;
a heating mechanism that heats and softens the residual layer;
a pressing mechanism that presses a metal porous material arranged on a surface of the residual layer to the residual layer softened by the heating mechanism to press-fit at least parts of the residual layer into open holes of the metal porous material; and
a peeling mechanism that peels off the metal porous material in which the residual layer is press-fitted into the open holes from the substrate.

9. The residual layer removal device according to claim 8, wherein the metal porous material is pressed by the pressing mechanism such that opening hole edges of the metal porous material come in contact with the substrate.

10. The residual layer removal device according to claim 8, wherein the metal porous material is a planar body having a knitted structure formed of metal wires.

11. The residual layer removal device according to claim 10, wherein each of the metal wires has a diameter smaller than an average layer thickness of the residual layer.

12. A display module using a substrate regenerated by removing a residual layer of an adhesive resin attached to the substrate,
wherein the residual layer of the substrate is removed by a residual layer removal method including:
an arranging step of arranging a metal porous material on a surface of the residual layer;
a heating step of heating and softening the residual layer;
a pressing step of pressing the metal porous material arranged on the surface of the residual layer by the arranging step to the residual layer softened by the heating step to press-fit at least parts of the residual layer into open holes of the metal porous material; and
a peeling step of peeling off the metal porous material in which the residual layer is press-fitted into the open holes from the substrate.
